(19) United States
(12) Patent Application Publication
(10) Pub. No.: US 2016/0302453 A1
(43) Pub. Date: Oct. 20, 2016

(54) Microwave Enhanced Refrigeration Preservation

(71) Applicants: Galen Suppes, Columbia, MO (US); Kimberly Suppes, Columbia, MO (US)

(72) Inventors: Galen Suppes, Columbia, MO (US); Kimberly Suppes, Columbia, MO (US)

(73) Assignees: Galen Suppes, Columbia, MO (US); Kimberly Suppes, Columbia, MO (US)

(21) Appl. No.: 15/043,690

(22) Filed: Feb. 15, 2016

Related U.S. Application Data
(60) Provisional application No. 62/116,857, filed on Feb. 16, 2015.
(60) Provisional application No. 62/129,261, filed on Mar. 6, 2015.
(60) Provisional application No. 62/292,266, filed on Feb. 6, 2016.

(51) Int. Cl. A23L 3/01; B65D 79/00; B65D 43/02; B65D 81/34; B65D 41/04; B65D 81/38

(52) U.S. Cl. CPC A23L 3/01; B65D 41/0435; B65D 81/3876; B65D 43/0204; B65D 81/3453; B65D 79/005; A23V 2002/00

(57) ABSTRACT

This invention is a is a pasteurizing device and method based on microwave heating of a food or beverage in a container. The device is a lid and container comprising a pressure release device that allows excess pressure to be released as water vapors evaporate and cause pressure buildup during microwave heating. It includes additional devices to enhance the approach such as an insulating cuzie that reduces temperature gradients in the food or beverage.

### CROSS REFERENCE TO RELATED APPLICATIONS

This application claims benefit of the following provisional applications: Ser. No. 62/116,857, filed Feb. 16, 2015, entitled “Energy Saving Inventions”; Ser. No. 62/129,261, filed Mar. 6, 2015, entitled “Energy Saving Inventions”; and Ser. No. 62/292,266, filed Feb. 6, 2016, entitled “Energy Saving Inventions”.

### FIELD

The present invention relates to a method for preserving foods. More specifically, it is a microwave method to enhance food and beverage refrigeration storage life.

### BACKGROUND

Partial pasteurizing or sterilizing in a microwave can be commonly and affordably used in households to reduce food and beverage spoilage. For example, when buying a gallon of milk, the milk can be separated into quart quantities s of that milk, treated separately in the microwave, sealed, and stored in the refrigerator for a refrigerator life longer than with a single opened gallon container. When a canned food bought at a store is half-consumed, microwave-enhanced preparation for refrigeration can be used to extend refrigerator shelf life.

### SUMMARY

This invention is a pasteurizing device and method, but neither a pasteurizing method that specifically meets pasteurizing standards for storage at room temperature nor a method that meets any of a number of standards for pasteurizing. Herein, pasteurizing refers to a method that kills some micro-organisms and seals a food or beverage to allow longer storage in a refrigerator.

This invention is a method, and devices of that method, for improved used of microwave heating for pasteurizing food and beverages. One device of this invention is a food container with a lid that releases pressure (above atmospheric pressure) when heating in the microwave and forms a seal when venting is complete and the pressure reduces as the container contents cool.

### BRIEF DESCRIPTION OF THE DRAWINGS

FIG. 1 is an illustration of a container device, sealing lid, and screw-top trap lid.

FIG. 2 is an illustration of the container with a sealing trap lid with a temperature indicator on the container.

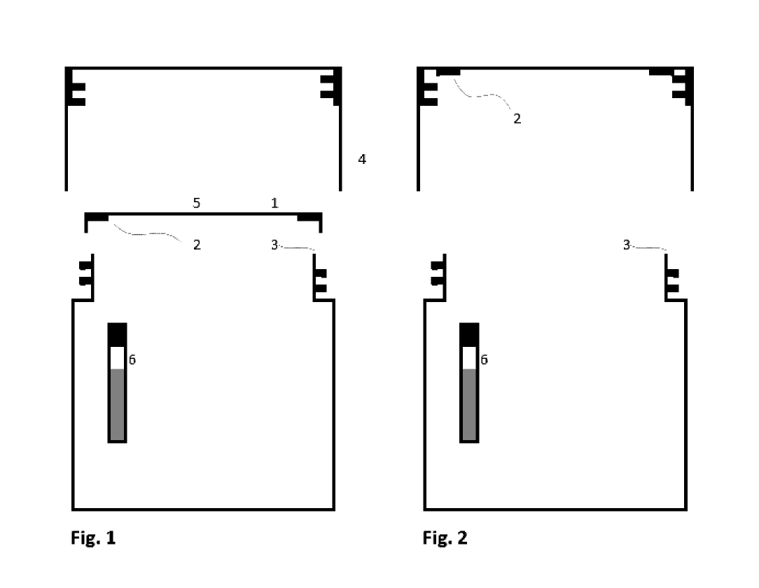

### DETAILED DESCRIPTION

An embodiment of this invention is a microwave pasteurizing device comprising: a container, a container's mouth which is an opening at the top of container through which food or beverages are placed in the container, a container's rim which is a surface on the top of the container that surrounds the mouth, a lid, a lid's inside surface that covers the container mouth when secured on the container, a lid's sealing perimeter surface that forms a seal between the lid and the container's rim, a lid's securing perimeter that forms a force with the container to keep the lid on the container, a pressure-release opening that releases pressure from the container when the pressure in the container is greater than atmospheric pressure, and a sealing surface around the pressure release opening that seals when pressure in the container is less than atmospheric pressure.

A lid embodiment (also referred to as the “cap”) is sealed by the pulling force of vacuum in the container, microwave compatible, and able to release pressure. Steam generated from the liquid being canned will heat the cap and is released taking with it some of the air in the container. At the end of the microwave energy input the water vapors condense whereby the reduced amount of air leads to vacuum and the sealing of the contents. Here, it is preferred to have a temperature strip indicator on the cap to confirm that the cap has reached pasteurizing temperatures. The cap may be a snap-on cap, a threaded cap, or other form of cap known in the art.

A threaded cap has screw threads that, when engaged, provide a force to hold the lid on the container. Such a lid may have a first part comprising the inner surface and sealing perimeter, a lid's second part comprising a screw-cap securing perimeter and a lip above and to the inside of the threads where the lip holds the lid's first part on the container, and a spring between the lip and the lid's first part where the spring pushes the lid's first part onto the rim with the pushing force increasing with greater separation between the lid's first part and the rim. Alternative to a spring, a compressive mechanism may be used that provides the same function as the spring. The lip of the lid's second part may form a continuous sealing surface above the lid's first part to functionally create a second container 4 that would contain any liquids escaping from the (first) container if the (first) container is inverted. This second container 4 may be removable after vacuum forces secure a sealing lid's first part 5 on the container.

The lid 1 embodiment releases pressure when the pressure inside the container is more than 0.5 atm above ambient pressure, more preferably when the pressure is more than 0.1 atm above ambient pressure, and most preferrably when the pressure is more than about 0.01 atm above atmospheric pressure. These 0.5, 0.1, and 0.01 differential pressures are referred to threshold gauge pressures (or TGPs). At internal pressures below these TGPs, the lid forms a seal where the force holding sealing surfaces together becomes stronger as the pressure in the container becomes lower.

One embodiment of a microwave canning lid 1 is a plastic cap with a plastic back-pressure valve connected to the cap. The backpressure valve is arranged to allow flow of gases out but not in. An example backpressure valve is comprised of a tube containing a ball that is held next to a valve seat with a spring where the force of the spring determines the value of the TGP. Alternatively, a pressure release device such as the backpressure valve is on the container rather than the lid.

An alternative embodiment is a snap-on lid comprised of a flat surface with a sealing perimeter surface 2 (e.g. washer-type surface). The container includes a mouth at the jar's top with a rim 3 surrounding the mouth and upon which the sealing perimeter 3 of the lid forms a seal. Outside the jar's rim 3 is an outer perimeter that is perpendicular to the sealing surface is a rim 3. The lid further comprises an elastic lip outside the perimeter surface 2 where the lip has an inner surface that is perpendicular to the perimeter surface 2. The lip has elastic capabilities that allows it to snap onto and outer perimeter of the rim of the container. The lid is further comprised of at least one passage that is a slot or other type of hole between the lid's perimeter surface and the lip's inner surface

Functionally, pressure inside the container pushed up on the flat surface of the lid which pulls the sealing inner perimeter surface 2 away from the rim 3 and allows gases to flow through the passage. This action occurs with the lip inner surface remaining in contact with the outer perimeter of the container. The elastic nature of the lip and corresponding part of the lid allows the passage and rim seal near the passage to open and close with the elastic nature of the lid pulling the sealing perimeter surface 2 back onto the rim 3 when the pressure in the container is lowered. Factors that impact the resulting TGP are a) size and shape of the passage, b) thickness of the lid/lip at the passage, and c) the elasticity of the materials around the passage.

Having described two methods of reducing the microwave canning lid, there are additional methods of making a canning lid as can be defined by those knowledgeable in the art or science. The basic embodiment is a lid of the described performance characteristics rather than any single method of reducing that lid to practice.

The snap-on lid 1 may use an elastic lip for holding the lid on the rim of the container or other methods (e.g. screw threads) known in the art. The container is not limited to the shape of a container and may have a range of vessel shapes consistent with storing liquids or food.

It is advantageous to have a container with a height to diameter ratio greater than 4 and more preferably greater than 5. The advantage is that this design reduces the average distance between the container contents and the vessel wall which allow more-even exposure to microwave heating radiation.

Illustrative example 1 provides data on the microwaveable container lid 2 with passages. The example illustrates that the detailed design of the size and number of holes must be coordinated with the rate (power level) at which the lid is designed to accommodate the escape of vapors. One method of achieving the proper design is by trial and error that can be completed in about a days of experimental effort.

The illustrative example indicates that the best results would be obtained for a lid designed to selectively bulge upward at the location where the passages (e.g. orifices for release of gases from the container) are in the lid. This can be attained by a number of methods known in the art. Furthermore, since a vacuum is formed in the vessel, it is desirable to make the lid out of plastic that would not substantially deform from the combination of heat and vacuum. To assist with achieving higher temperatures, the lid may a good thermal insulation capacity.

A snap-on lid embodiment uses an elastic perimeter to provide the force that secures the lid on the container. An option is to have the pressure release opening be an orifice in the elastic perimeter of the lid comprising: an orifice sealing surface around the orifice on the side of the elastic perimeter next to the container's rim, whereby the orifice sealing surface forms a seal with the rim.

Cannery System Cuzie—A refrigerated cannery system is a microwave-based approach to increasing refrigeration life of foods and beverages. The final products of this project will be consumer containers with lids, procedures for properly using the containers/lids, and ancillary devices or upgrades such as color-coded temperature indicators 6 on containers or microwaves that are pre-programmed for canning-type operations.

A most general aspect of the invention is a microwavable lid that releases pressure before it builds up in the container while providing a seal upon cooling. This general embodiment is made more specific in claims related to the simple design of a lid with a hole in the lid that is placed over part of the sealing surface of the container/jar to allow for pressure release.

Embodiments of this invention may be referred to as a refrigerated cannery system. An embodiment of the refrigerated cannery system comprising placing a cuzie (like a sock placed around the lower portion of a container) on a container with a self-releasing-self-sealing lid where the cuzie functionally provides thermal insulation on at least the lower half of the sides of the container whereby this reduces the rate at which heat is lost from the vessel and thereby allows more time for heat to conduct/diffuse into the middle portions of the vessel.

The cuzie reduces heat losses to the surroundings, and thereby, enhances a more-even temperature distribution throughout the food or beverage in the container.

The cuzie is a device comprising a thermally insulating sleeve that surrounds at least half of the outside surface of the container.

Self-Heating Lid—In one embodiment, the cap itself is heated from microwaves either due to its composition or due to water that is adsorbed into a component of the cap which evaporates and ends microwave heating after a temperature near 167 degrees F. is reached. A design feature of this cap is to remain intact at temperatures and times necessary to bring the container contents to pasteurizing temperatures. Here, the embodiment is a lid containing materials susceptible to microwave induction heating.

Embodiments of this invention can be used for sterilizing liquids (e.g. milk) and food. For milk, sterilizing consists of heating to higher temperatures (e.g. 250 degrees F.). Heating water to higher pressures includes use of TGPs higher than 1.5 atm where higher TGPs lead to higher temperatures and better sterilization. A method for achieving this is comprised of a container with screw threads around the outer perimeter of the jar's mouth that accepts a metal band. When screwed down, the band presses a separate disc-shaped lid against the rim of the container where an integral rubber ring on the underside of the lid creates a seal on the container. The improvement being a spring that is placed between the lid and the band so that the lid will lift after a certain pressure is reached in the container as corresponding to the desired temperature for pasteurizing or sterilizing. When heating ends, boiling stops, and pressure reduces, the spring presses the lid onto the container and creates a seal as the container cools.

Cannery System Steaming Tray—An embodiment of the refrigerated cannery system comprising a container with a steaming tray in a container allows water to be placed below a food item with steam being generated to heat the outside of the food. This could be used for leftovers or for fresh vegetables where it is not desirable to “cook” the food item with an emphasis on sterilizing the outer surface. To advantage, this would extend the refrigerator storage of items line green beans and broccoli. Here, one embodiment is a steam tray comprising: a steam tray capable of holding solid food where said tray is 0.1 to 0.9 inches from the bottom of the inside of the inside bottom of the container and where food is placed on the tray and water is placed below they tray.

Cannery Microwave Programming Method—An embodiment of a refrigerated cannery system comprising programming specific to pasteurizing process includes an initial high power level with a prolonged end cycle at a lower power level to attain boiling temperatures without splattering; further comprising a control methodology that reduces microwave power output to maintain the surface of the container below the boiling point of the liquid which is important to prevent vigorous splatter of material that can interfere with sealing surfaces around the pressure release mechanism. Here, one embodiment is a microwave programming method to control input of microwave energy comprising: a time interval for heating the food or beverage to a temperature greater than 140 degrees Fahrenheit, a first one fifth of the time interval where the power setting on the microwave is greater than six tenths of the maximum power setting of the microwave, and a final one-fifth of the time interval where the power setting on the microwave is on the average less than four tenths of the maximum power setting of the microwave.

Here, one embodiment of the invention is a microwave programming method to control input of microwave energy comprising: a time interval for heating the food or beverage to a temperature greater than 140 degrees Fahrenheit, a first one fifth of the time interval where the power setting on the microwave is greater than six tenths of the maximum power setting of the microwave, and a final one-fifth of the time interval where the power setting on the microwave is on the average less than four tenths of the maximum power setting of the microwave.

Alternatively, one embodiment of the invention is a microwave feedback control method to control input of microwave energy comprising: placing a temperature measurement device on the outer surface of the container where said temperature measurement device send an electrical signal to a control unit in the microwave, and an algorithm of the control unit that adjusts the power output of the microwave to keep the temperature of the wall of the container at a value below a set point where the set point is below the boiling point of water and above 140 degrees Fahrenheit.

Cannery Microwave Baffle Inserts—An embodiment of the refrigerated cannery system comprising a removable baffle insert that is placed in the microwave container having surfaces comprising baffles where baffle edges are along the container wall and the baffle surface slopes inward and upward thereby diverting heat-generated convection that is along the surface to the inside of the vessel. Here, one embodiment of the invention is a removable baffle insert that is placed in the beverage in the container that remains in the beverage during storage where the baffle insert is comprised of at least one baffle surface with a lower edge of the baffle surface along the inner wall of the container

Upside Down Treatment—The preferred method for storing food is comprised of placing food or drink in a container, heating the container in a microwave, placing a sealing lid on the container, securing the sealing lid on the container, placing container upside down for a period of time no less than seconds. The placing of the container upside down assures that the sealing lid is heated to a temperature that is hot enough to kill microorganisms on the lid. The lid may or may not be placed in the microwave. If the lid is not microwave-proof, it is possible that it could be placed in a separator container of water and heated in that container in the microwave.

Spill-Containing Lid—The devices for the method further comprising a securing device where the securing device is a trap that has a volume at least one fifth the volume of the container but less than four fifths the volume of the container. Unlike the screw-cap securing devices used with a common Kerr canning container, the preferred securing device is not open on top, and if used with a separate securing lid, the contact from the device to the lid is around a circumference the concentrates a force that secures the sealing surface of the lid to a sealing upper lip on the container.

More preferably, the pasteurizing method includes a method of securing comprising screwing a securing lid onto the container.

An option is for the securing lid and sealing lid are one and the same device. Another option is for a temperature indicator to be on the container.

The container0 is preferably a glass container. More-preferably, the container is a glass canning container.

Base for Tightening—An option is for the container to have a non-circular circumference on the bottom part of the container that allows for easy grasping to loosen or tight. Optionally is a device comprising a base separate from the container such that the base is able to be placed on a countertop further comprising a crevice in the base such that the bottom part of the container fits into the crevice and will not rotate. More preferably, the crevice is square in shape (a square crevice) and the bottom part of the container is square in shape with rounded edges consistent with glass jars having square perimeters.

Lid with Elastic Sides and Rigid Center—The method is not limited to container with screw lids. The securing lid optionally has an elastic perimeter that fits over an upper lip 24 of the container to secure the lid on the container. The securing lid with an elastic perimeter such that a portion of the lid inside the perimeter is not elastic at temperatures less than a temperature of 200 degrees F.

Pasteurization Defined—The microwave cannery system differs from a coffee cup in that it has a cap that seals (a jar), and preferably seals due to the creation of a vacuum pressure in the container. Pasteuring includes the heating of both the container and the lid to a temperature that will kill micro-organisms. For example, a temperature of 162 degrees F. for seconds for milk or 140 degrees F. for 20 minutes. A typical goal for microwave pasteurizing would be a temperature of 154.5 degrees F. for at least a minute.

Handle Embodiment—To make the handling of hot jars, preferably, the jars of a permanent or temporary insulated handle for use in the microwave. The insulated handle could be a separate column in parallel with the container or a narrow part of the container where the narrow part of the container is less than about 7 inches (preferably less than 6 inches) in circumference. The insulation layer would have a thermal conductivity at least 80% less than the thermal conductivity of glass.

An advantage of having a handle that is parallel to the container vessel is that the container could be laid on its side without danger of rolling off a counter after the cap is placed on the container. Laying the container on its side allows for the cap to be heated and pasteurized along with the milk.

### ILLUSTRATIVE EXAMPLE 1

A commercially available 2-cup Pyrex storage bowl with a plastic lid was modified to create a passages where the flap part of the lid met the lip that was on the perimeter of the lid. Water was placed in the bowl, the lid was placed on the bowl, and the bowl was placed in the microwave until considerable boiling with release of steam was observed. The following modifications, tests, and observations were made:
a) For a 0.4 slot punctured with a knife and on a full power setting, the lid popped off in about 20 seconds. The lid bulged up in the middle before popping off.
b) For a single 0.1 inch diameter hole drilled into the lid, and on a full power setting, the lid popped off in about 20 seconds. The lid bulged up in the middle before popping off.
c) For three 0.1 inch diameter holes drilled into the lid, and on a full power setting, the lid rose up a bit and bobbled around, but when the power was turned off, it settled back into position and sealed as the contents of the vessel cooled. The sunken center of the lid indicated a vacuum had formed in the bowl upon cooling.
d) For three 0.1 inch diameter holes drilled into the lid, and on a 50% power setting, the lid stayed secured and vapors escape, but when the power was turned off, it settled back into position and sealed as the contents of the vessel cooled. The sunken center of the lid indicated a vacuum had formed in the bowl upon cooling.

What is claimed is:

1. A microwave pasteurizing device comprising:
a container,
a container's mouth which is an opening at the top of container through which food or beverages are placed in the container,
a container's rim which is a surface on the top of the container that surrounds the mouth, a lid,
a lid's inside surface that covers the container mouth when secured on the container,
a lid's sealing perimeter surface that forms a seal between the lid and the container's rim,
a lid's securing perimeter that forms a force with the container to keep the lid on the container,
a pressure-release opening that releases pressure from the container when the pressure in the container is greater than atmospheric pressure, and
a sealing surface around the pressure release opening that seals when pressure in the container is less than atmospheric pressure.

2. The pasteurizing device of claim 1 where the securing perimeter is screw threads of a screw-cap lid.

3. The pasteurizing device of claim 2 comprising:
a lid's first part comprising the inner surface and sealing perimeter,
a lid's second part comprising a screw-cap securing perimeter and a lip above and to the inside of the threads where the lip holds the lid's first part on the container, and
a spring between the lip and the lid's first part where the spring pushes the lid's first part onto the rim with the pushing force increasing with greater separation between the lid's first part and the rim.

4. The pasteurizing device of claim 3 comprising a compressive mechanism in place of the spring that provides the same function as the spring.

5. The pasteurizing device of claim 3 where the lip of the lid's second part forms a continuous sealing surface above the lid's first part to functionally create a second container that would contain any liquids escaping from the (first) container if the (first) container is inverted.

6. The pasteurizing device of claim 1 where the securing perimeter is an elastic perimeter of a snap-on lid.

7. The pasteurizing device of claim 6 where the pressure release opening is an orifice in the elastic perimeter of the lid comprising:
an orifice sealing surface around the orifice on the side of the elastic perimeter next to the container's rim, whereby
the orifice sealing surface forms a seal with the rim.

8. The pasteurizing device of claim 1 comprising a check valve that allows flow of gas out the vessel and seals against flow of gas into the vessel.

9. The pasteurizing device of claim 1 comprising a container cuzie with said cuzie comprising:
a thermally insulating sleeve that surrounds at least half of the outside surface of the container.

10. The pasteurizing device of claim 1 comprising a lid containing materials susceptible to microwave induction heating.

11. The pasteurizing device of claim 1 with a steam tray comprising:
a steam tray capable of holding solid food where said tray is 0.1 to 0.9 inches from the bottom of the inside of the inside bottom of the container and
where food is placed on the tray and water is placed below they tray.

12. The pasteurizing device of claim 1 comprising a microwave programming method to control input of microwave energy comprising:
a time interval for heating the food or beverage to a temperature greater than 140 degrees Fahrenheit,
a first one fifth of the time interval where the power setting on the microwave is greater than six tenths of the maximum power setting of the microwave, and
a final one-fifth of the time interval where the power setting on the microwave is on the average less than four tenths of the maximum power setting of the microwave.

13. The pasteurizing device of claim 1 comprising a microwave feedback control method to control input of microwave energy comprising:
placing a temperature measurement device on the outer surface of the container where said temperature measurement device send an electrical signal to a control unit in the microwave, and
an algorithm of the control unit that adjusts the power output of the microwave to keep the temperature of the wall of the container at a value below a set point where the set point is below the boiling point of water and above 140 degrees Fahrenheit.

14. The pasteurizing device of claim 1 for use with liquids comprising:
a removable baffle insert that is placed in the beverage in the container that remains in the beverage during storage where the baffle insert is comprised of at least one baffle surface with a lower edge of the baffle surface along the inner wall of the container.

15. A method for microwave pasteurization comprising:
placing food or beverage in a container,
placing a sealing lid on the container, and
heating the container contents in a microwave, where
the securing lid has an elastic perimeter that fits over an upper rim of the container to secure the lid on the container where the portion of the lid between the elastic perimeter is not elastic at temperatures less than 200 degrees Fahrenheit.
